(19) United States
(12) Patent Application Publication
(10) Pub. No.: US 2025/0190807 A1
(43) Pub. Date: Jun. 12, 2025

(54) SYSTEM AND METHOD FOR MODEL COMPOSITION OF NEURAL NETWORKS

(71) Applicant: HUAWEI CLOUD COMPUTING TECHNOLOGIES CO., LTD., Gui'an New District (CN)

(72) Inventors: Amin BANITALEBI DEHKORDI, Kanata (CA); Xinyu KANG, Kanata (CA); Xiaolong BAI, Shenzhen (CN); Yong ZHANG, Kanata (CA)

(21) Appl. No.: 18/535,639

(22) Filed: Dec. 11, 2023

Related U.S. Application Data
(63) Continuation of application No. PCT/CN2021/100957, filed on Jun. 18, 2021.

(51) Int. Cl. G06N 3/09

(52) U.S. Cl. CPC G06N 3/09

(57) ABSTRACT

Method and system for generating a composite neural network (NN) model that is based on a group of source NN models, including providing a dataset including a plurality of input samples to each of the source NN models; receiving, from each of the source NN models, a respective set of label predictions for the input samples of the dataset; selecting, from among the received sets of label predictions, representative label predictions to use as pseudo-labels for the input samples; and performing supervised training of a target NN model using the pseudo-labels and the input samples to generate the composite NN model.

### RELATED APPLICATIONS

This application is a continuation of International Application No. PCT/CN2021/100957, filed Jun. 18, 2021, the contents of which are incorporated herein by reference.

### TECHNICAL FIELD

The present disclosure relates to machine learning (ML) systems, specifically systems and methods for generating a ML model that is a composition of multiple neural network (NN) models.

### BACKGROUND

Machine learning (ML) uses computer algorithms that improve automatically through experience and by the use of data. A machine learning algorithm can be used to train a ML model based on training data samples obtained from a training dataset to learn values of a set of parameters of the ML model so that the trained ML model can make predictions or decisions without being explicitly programmed to do so. Neural Network (NN) models are types of ML models that are based on the structure and functions of biological neural networks.

NN models are considered nonlinear statistical data modeling tools where the complex relationships between inputs and outputs present in training data samples are modeled to enable outputs to be predicted for new input data samples (“input samples”). In this disclosure, a “NN model” can refer to a NN that has a particular architecture and is trained using a machine learning algorithm and a training dataset for a specific type of prediction task. Typically, a NN model is provided by selecting an architecture for the NN model (“NN model architecture”), then using a machine learning algorithm and a training dataset to learn values of a set of NN parameters (e.g., weights and biases) of the NN model. The NN model, once trained, can be referred to as a trained NN model for the specific type of prediction task. The trained NN model can make predictions or decision on new input samples for the specific type of prediction task it was trained for.

NN model architectures and their respective trained NN models, for the same type prediction task, can have varying levels of architectural complexity that can impact the number, composition and interconnection of NN layers in a model. NN model architectures can fall within a number of categories, including but not limited to deep neural network (DNN) models, convolution neural network (CNN) models, recurrent neural network (RNN) models, long/short term memory (LSTM) models, and combinations thereof. Different NN models for the same type of prediction task may be trained using different training datasets and hence each different NN model can generate a different prediction.

ML has enabled achieving outstanding results for a wide range of applications, including computer vision and image processing applications, natural language processing applications, and other data processing applications. However, the diversity of NN model architectures necessitates a careful selection of an NN model architecture and training dataset that match best to a target type of prediction task. Often times, for the same type of prediction task, many alternative NN models may be available. These models might be trained on different datasets, or might come in different capacities, architectures, or even bit precisions. Moreover, they can be created by different model owners (for example, entities that provide NN models in a cloud computing environment).

Attempts have been made to combine multiple NN models that perform the same type of prediction task to provide a combined NN model that performs the same type prediction task as the multiple NN models. One known method for combining multiple NN models is referred to as network ensembling. In network ensembling, the output predictions of multiple NN models for the same input sample are combined (e.g., using naïve averaging) to provide a resulting prediction. In some cases, network ensembling can be combined with knowledge distillation to train a single NN model based on the predictions of multiple NN models (which are generally referred as teacher NN models), however, in such cases each of the teacher NN models must have the same homogeneous set of candidate labels.

Other known methods for combining multiple NN models create a new architecture for a NN model that performs the same type of prediction task as the multiple NN models based on known architectures of other NN models that perform the same type of prediction task. However, in order to support heterogeneous label sets, such methods require the use of a training dataset that includes a large number of labelled training data samples.

Another known method applies dataset merging that combines datasets. However, such a method also requires labelled training datasets and also places strict limits on the architecture of NN model.

Among other things, known solutions typically have one or more of the following shortcomings: (1) they require a specific NN model architecture; (2) they require access to one or more of a labelled training dataset and/or the NN parameters of multiple NN models being combined; and/or (3) they require NN models that all have the same set of candidate labels (e.g., homogenous labels across all models).

There is a need for a system and method for combining NN models that can address these shortcomings.

### SUMMARY

According to a first aspect of the disclosure a method is disclosed for generating a composite neural network (NN) model that is based on a group of source NN models, comprising: providing an unlabeled dataset including a plurality of input samples to each of the source NN models; receiving, from each of the source NN models, a respective set of label predictions for the input samples of the unlabeled dataset; selecting, from among the received sets of label predictions, representative label predictions to use as pseudo-labels for the input samples; and performing supervised training of a target NN model using the pseudo-labels and the input samples to generate the composite NN model.

The selection of representative label predictions from among the received sets of label predictions may, in some applications, provide a benefit of allowing a most desirable label prediction to be used for each respective input sample across the data set, enabling training of an accurate target NN model that can emulate the most desirable predictions of the group of source NN models.

In some examples of the method of the first aspect, the source NN models are each configured to generate label predictions by mapping input samples to one or more possible label predictions included in a respective set of candidate labels, wherein at least some of the source NN models have different respective sets of candidate labels.

The inclusion of source NN models having different respective sets of candidate labels may, in some applications, provide a benefit of enabling disjointed label sets of source NN models to be combined into a single label set of the target NN Model.

In one or more of the methods of the preceding aspects, the received sets of label predictions include prediction accuracy data that indicates a prediction accuracy, and selecting representative label predictions to use as pseudo-labels for the input samples comprises filtering label predictions based on the prediction accuracy data.

In one or more of the methods of the preceding aspects, the prediction accuracy data comprises label prediction confidence values for at least some of the label predictions, and filtering label predictions based on the prediction accuracy data comprises removing label predictions from the received sets of label predictions that do not meet a threshold label prediction confidence value.

In one or more of the methods of the preceding aspects, the prediction accuracy data comprises probabilities for all possible label predictions for at least some of the label predictions, and filtering label predictions based on the prediction accuracy data comprises: calculating an entropy score for each of the at least some label predictions based a distribution of the probabilities for all possible label predictions for the label prediction; and removing label predictions from the received sets of label predictions that exceed a threshold entropy score.

In one or more of the methods of the preceding aspects, selecting representative label predictions to use as pseudo-labels for the input samples comprises: aggregating, for each input sample, a list of label predictions that the source NN models have predicted for the input sample, and selecting the representative label prediction for the input sample from the list of label predictions for the input sample.

In one or more of the methods of the preceding aspects, the source NN models are each configured to perform image classification and output a highest probability label prediction for each input sample, wherein selecting the representative label prediction for the input sample from the list of label predictions for the input sample is based on selecting the label prediction having a highest associated probability.

In one or more of the methods of the preceding aspects, the source NN models are each configured to perform an object detection task prediction wherein objects are detected in each input sample and associated with a respective bounding box prediction and object label prediction, wherein selecting representative label predictions to use as pseudo-labels for the input samples comprises: for each input sample: aggregating a list of bounding box predictions and label predictions for each of the objects detected in the input sample by the source NN models; identifying each unique object having bounding box predictions and label predictions included in the list by identifying objects that have the same label predictions and have bounding box predictions that meet a defined overlap criteria; selecting an object label for each of the identified unique objects from the label predictions provided by the source NN models in respect of the unique objects; and using the selected object labels as the representative label predictions for the input sample.

In one or more of the methods of the preceding aspects the method further includes filtering the identified unique objects prior to selecting the object labels, comprising removing from the identified unique objects any objects that have not been provided the same label prediction by a threshold ratio of the source NN models.

In one or more of the methods of the preceding aspects, the method includes receiving an input from a user interface indicating the threshold ratio.

In one or more of the methods of the preceding aspects, the method includes receiving, through a user interface, selection information indicating the source NN models to include in the group of source NN models, wherein the source NN models are all configured to perform a same type of prediction task that is intended for the target NN model, but at least one of the source NN models has a different NN model architecture than one or more of the other source NN models.

In one or more of the method of the preceding aspects, providing the dataset to each of the source NN models comprises submitting the dataset through a cloud network to the source NN models.

In one or more of the method of the preceding aspects, the method includes receiving, through a user interface, target model selection information indicating the intended type of prediction task for the target NN model and a model architecture for the target NN model.

According to a further example aspect a computer system is disclosed comprising one or more processing units and one or more non-transient memories storing computer implementable instructions for execution by the one or more processing devices, wherein execution of the computer implementable instructions configures the computer system to perform the method of any one of the preceding aspects.

According to a further example aspect, a non-transient computer readable medium is disclosed that stores computer implementable instructions that configures a computer system to perform the method of any one of the preceding aspects.

### BRIEF DESCRIPTION OF THE DRAWINGS

Reference will now be made, by way of example, to the accompanying drawings, which show example embodiments of the present application, and in which:

FIG. 1 is a block diagram of a model composition system according to example aspects of this disclosure;

FIG. 2 is a block diagram illustrating the model composition system of FIG. 1 in greater detail, according to an example of the present disclosure;

FIG. 3 is a block diagram illustrating a filtering operation of a filter module of the model composition system of FIGS. 1 and 2, according to an example of the present disclosure;

FIG. 4 is an example of pseudocode to enact the aggregation module of the model composition system of FIGS. 1 and 2, according to an example of the present disclosure;

FIG. 5 is a block diagram illustrating operation of an aggregation module of the model composition system of FIGS. 1 and 2, according to an example of the present disclosure;

FIG. 6 is a block diagram illustrating a model refinement module of the model composition system of FIG. 1, according to an example of the present disclosure;

FIG. 7 is a block diagram of an example processing system that may be used to implement examples described herein; and

FIG. 8 is a block diagram illustrating an example hardware structure of a NN processor, in accordance with an example embodiment.

Similar reference numerals may have been used in different figures to denote similar components.

### DETAILED DESCRIPTION

Examples are disclosed of systems and methods for combining multiple source NN models that have been trained to perform the same type of prediction task into a single composite target NN model that can perform the same type of prediction task as the multiple source NN models.

Among other things, one or more of the following benefits may be realized by combining the multiple source NN models into a single target NN model: the prediction latency of using multiple NN models may be reduced as only one inference needs to be performed using a single NN model which generates a prediction, such as a class label from a defined set of candidate class labels, for a given input sample provided to the single target NN model as opposed to multiple inferences that need to be performed using respective NN models of the multiple NN models where each respective source NN model generate a prediction, such as a class label, for the given input sample; in cases where multiple source NN models cover partially overlapping or non-overlapping sets of candidate class labels, a single target NN model can be provided that covers a union of the sets of candidate class labels that are collectively provided by the multiple source NN models (e.g., the sets of candidate class labels of multiple source NN models can be merged); and for applications involving NN model deployment, e.g. for cloud computing services providers, the deployment of a single trained target NN model to a computing device requires the computing device to have significantly less memory, when compared to the memory require for deployment of multiple source NN models to the same computing device. Further, the size of a file that contains the instructions of the single target NN model is significantly less than the size of a file that contains the instructions for the multiple source NN models.

Furthermore, the presently disclosed methods and systems may, in one or more configurations: support combination of an arbitrary number of source NN models having arbitrary NN model architectures; leverage the abundant availability of unlabeled data as neither labelled data or the original training data of the source NN models is required (if any labelled data is available, it can be used to further boost performance of a target NN model); have no requirements for source model NN code or parameters (in examples, only an application program interface (API) to a model composition system is required to send input samples to the model composition system to be used by the trained target NN mode during inference to generate predictions); and place no restrictions on the number and composition of predictions (e.g. label prediction) generated by each respective source NN model (e.g., can support non-overlapping or disjoint sets of candidate labels among the source NN models).

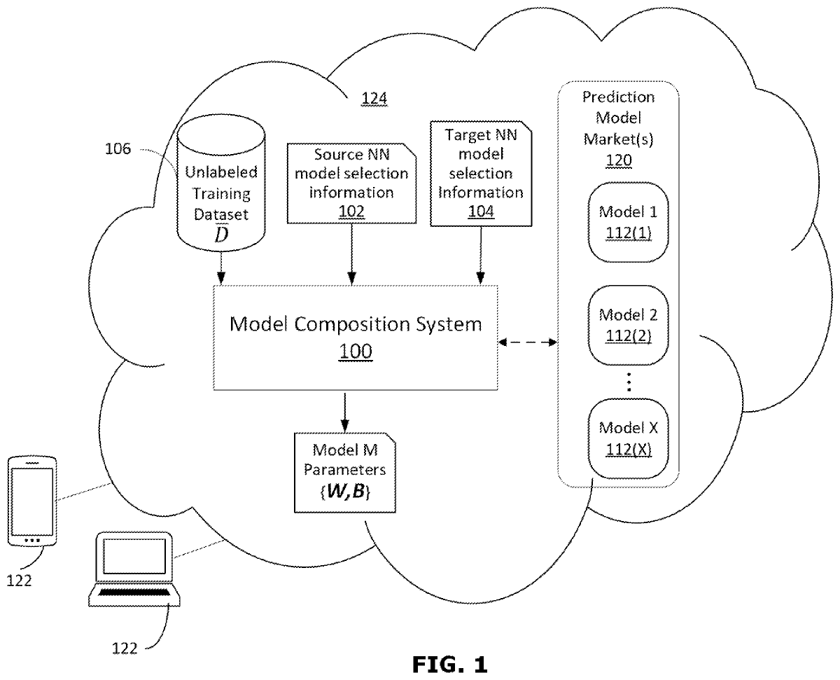

FIG. 1 is a block diagram showing a model composition system 100 and an environment in which the model composition system 100 may operate, according to examples of the present disclosure. The model composition system 100 is configured to use an unsupervised training algorithm and an unlabeled training dataset X to train a target NN model M that is a composition of multiple trained source NN models 1 to N.

In the example of FIG. 1, model composition system 100 can be hosted by a cloud computing system 124. The cloud computing system 124 that hosts model composition system 100 can include one or more computing devices (for example a server, a cluster of servers, a virtual machine, or a cluster of virtual machines) that have extensive computational power made possible by multiple powerful and/or specialized processing units and large amounts of memory and data storage. In some examples, the model composition system 100 provides a NN model generation service that can be accessed as a cloud computing service offered by a cloud computing provider to one or more users that have respective user devices 122 (otherwise known as client devices). A user device 122 may for example be an edge computing device (“edge device”) that connects through local networks via the Internet to the cloud computing system 124. Examples of user devices 122 are computer systems, smart-phones, desktop and laptop personal computers, tablet computers, smart-home cameras and appliances, authorization entry devices (e.g., license plate recognition camera), smart-watches, surveillance cameras, medical devices (e.g., hearing aids, and personal health and fitness trackers), various smart sensors and monitoring devices, and Internet of Things (IoT) devices.

In the example of FIG. 1, one or more prediction model markets 120 may be hosted by the same cloud computing system 124 that hosts model composition system 100, or by other computing systems or cloud computing systems that are connected to cloud computing system 124. The one or more prediction model markets 120 may be cloud computing services that host trained ML models (e.g., trained NN model 112(1) to trained NN Model 112(X)). In some examples, users devices 122 may be authorized to submit unlabeled datasets through one or more APIs to one or more of the trained NN models 112(1) to 112(X) (otherwise referred to as “the hosted NN models 112(1) to 112(X)” or “NN models 112(1) to 112(X)”) to receive corresponding predictions for the input data samples included in such unlabeled datasets. In some examples, users devices 122 may be able to download one or more trained NN models 112(1) to 112(X) and store the downloaded one or more trained models 112(1) to 112(X) in storage of the user device 122 or store the downloaded one or more trained models 112(1) to 112(X) in storage of a further computing system that the user device 122 is associated with.

The NN models 112(1) to 112(X) may include several different NN models that are specialized to perform various types of prediction tasks (otherwise referred to as “prediction tasks types” herein). Examples of different types of prediction tasks can include for example, whole image classification, object detection, semantic segmentation, text-to-speech conversion, speech recognition; optical character recognition (OCR); and natural language processing (NLP) sentiment prediction, among others. Furthermore, for each of the different types of prediction tasks, the NN models 112(1) to 112(X) may include multiple source

NN models (for example NN models 112(1) to 112(N), where NN Model 112 is used to denote a generic source NN model) that perform the same type of prediction task (for example, an object detection for input samples where the input samples are images). The source NN models 112(1) to 112(N) that perform the same type of prediction task may be a heterogeneous group of NN models. In this disclosure, a heterogeneous group of NN models that perform the same type of prediction task can refer to a group of non-identical NN models, where the differences between the NN models include one or more of: different NN model architecture; different sets of learned NN model parameters; different hyper-parameters; and different respective subject area specialties (e.g., different sets of candidate class labels), within a type of prediction task. For example, one of the source NN models 112(h) may be trained to detect and classify instances of “vehicle” objects in an input sample (e.g. an image), a further one of the source NN models 112(h+1) may be trained to detect and classify instances of “human” objects in the input sample (e.g. the image), and a further one of the source NN models 112(h+2) may be trained to detect and classify instances of “vegetation” objects in the input sample (e.g. the image), where h is an integer between 1 and N where N=3. Accordingly, each respective source NN model 112 is trained to perform a prediction task type that maps an input tensor (e.g., an input sample x) to a prediction (i.e. generates a prediction based on the input tensor (e.g. an input sample x). The prediction generated by a respective source NN model 112 may be a predicted label (otherwise referred to as a label prediction). In some embodiments, the predicted label (i.e. the label predication) may be a label (e.g. a class label) from a defined set of candidate labels (e.g. a defined set of candidate labels). In some embodiments, the prediction task type is object detection and the prediction generated by a respective source NN model 112 includes a predicted class label for each object detected in the input sample, predicted coordinates for a bounding box for each object detected in the input sample, and confidence value for each predicted class label as described in further detail below.

In examples where the source NN models of the same prediction task type have respective subject area specialties, the respective candidate class label sets of the source NN models will be different from each other. In some examples the respective candidate class label sets across the source NN models 112(1) to 112(N) may include overlapping candidate class label sets for at least some of the NN models, and in some examples the candidate class label sets may be identical for at least some of the NN models. In cases where different NN models have been trained to generate predicted class labels within the same set of candidate class labels, the different NN models may be configured differently either as a result of being trained with different training datasets, or by having a different NN architecture, or both. In some examples, one or more of source NN models 112(1) to 112(N) may come from different sources. For example, expert users may upload personal NN models to one or more prediction model markets 120, and commercial software developers may upload commercial NN models to one or more prediction model markets 120.

In the example of FIG. 1, a user device 122 can interact, via a cloud interface (e.g., a web browser or an API) of the user device 122, with model composition system 100 to enable a user of the user device 122 to order a customized target NN model M. In this regard, in the illustrated example, model composition system 100, receives, as user inputs, or default inputs, or as a combination of user and default inputs: (1) an unlabeled training dataset D that includes unlabeled data samples; (2) source NN model selection information 102 indicating a set of trained NN models 112(1) to 112(N) that are to be combined; and (3) target NN model selection information 104 indicating an NN model architecture that is to be used for target NN model M.

By way of example, in the case where the prediction task type is object detection, the unlabeled training dataset D could include a series or sequence of images as unlabeled input samples. In some examples, each unlabeled data sample included in the unlabeled training dataset D can correspond to a single captured image or a frame of a video. The source NN model selection information 102 can include identification of the source NN models 112(1) to 112(N), and in some cases, API and address information for accessing each of the source NN models 112(1) to 112(N). For example, in the case of the input samples being images, the existing NN model selection information 102 may include API and network address information for a set of source NN models 112(1) to 112(N) that are each configured to perform object detection.

In at least some examples, the model composition system 100 may provide a user, through an interface presented by user device 122, with the option to specify (for example, using a dropdown menu list) the prediction task types the target NN model M is intended to perform. For example, options such as: “(i) object detection; (ii) image classification; (iii) NLP processing”, could be presented, among other possible prediction task types. Once a user selects a prediction task type, further options can be presented that represent the available source NN models 112 in the one or more prediction model markets 120 that are configured to perform the selected prediction task type. By way of non-limiting example, the available trained NN models for object detection may include options such as: “EfficientDET-D0 trained on Pascal-VOC”; “EfficientDET-D1 trained on COCO”; “EfficientDET-D0 trained on Pascal-VOC and COCO”, “RetinaNet-ResNet50 trained on Pascal-VOC and COCO” and so on. The source NN models 112(1) to 112(N) can then be selected by a user from the listed options.

The target NN model selection information 104 may include information that specifies NN model architecture properties such as type of NN model, number of layers, composition of layers, and layer interconnections. In some examples, the target NN model selection information 104 may indicate a known NN model architecture. A user of a user device 122 can be presented with the option to select a target NN model architecture from list of predefined possible NN model architectures. For example, in the case where a user of a user device 122 selects prediction task type “object detection”, the available target, the NN model architecture options may include predefined NN model architecture options such as: “EfficientDET-D0”; “EfficientDET-D1”; “RetinaNet-ResNet50” and so on. The target NN model M architecture is then selected by the user from the listed options. In some examples, a user may have the option to specify NN model M hyper-parameters such as various optimizers, learning rate schedules, batch sizes, etc.

Based on the input unlabeled training dataset D̅, existing NN model selection information 102 (otherwise referred to as “source model selection information 102”) and target model M selection information 104, the model composition system 100 is configured to generate a trained target NN model M that functions as a combination of selected source NN models 102. In particular, in the illustrated embodiment, the model composition system 100 generates a set of learned parameters 108 that can be used with the specified NN model M architecture to configure and deploy a trained target NN model M.

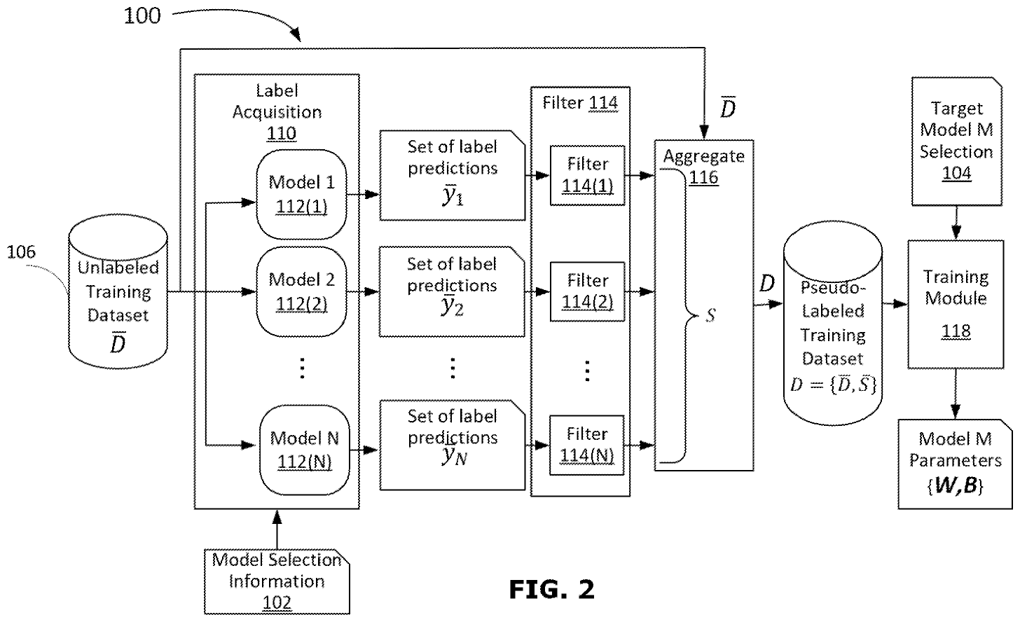

The operation of model composition system 100 will now be explained in greater detail with reference to FIG. 2. In the illustrated example, the model composition system 100 can comprise a plurality of modules that each perform a respective set of operations, including for example a label acquisition module 110, a filter module 114, an aggregate module 116, and a model M training module 118. As used here, a “module” can refer to a combination of a hardware processing circuit or device and machine-readable instructions (software and/or firmware) executable by the hardware processing circuit or device. A hardware processing circuit or device can include any or some combination of a microprocessor, a core of a multi-core microprocessor, a microcontroller, a programmable integrated circuit, a programmable gate array, a digital signal processor, or another hardware processing circuit. The same hardware processing circuit or device may be combined different sets of machine-readable instructions to enact multiple modules.

In some examples, the label acquisition module 110 receives the unlabeled training dataset D̅ from storage 106 as input, as well as the source NN model selection information 102. Label acquisition module 110 is configured to provide the unlabeled data samples included in the unlabeled training dataset D̅ as input samples to each of the selected source NN models 112(1) to 112(N) and each of the source NN models 112(1) to 112(N) is configured to generate a label prediction (otherwise referred to herein as a predicted label) for each respective unlabeled data sample in the unlabeled training dataset. Thus, each respective source NN model 112 generates a set of label predictions (otherwise referred to herein as a set of predicted labels) for the unlabeled data samples included in the unlabeled training dataset D̅. The sets of label predictions generated by the source NN model 112(1) to 112(N) are denoted y̅₁ to y̅_{N}, respectively. Each set of label predictions y̅ⱼ is a set that includes all label predictions generated by a respective source NN model 112 for all unlabeled data samples included in the unlabeled training dataset D̅. In example embodiments, the prediction generated by each respective source NN model 112 in respect of an unlabeled data sample of the unlabeled training dataset D̅ may be predicted data that include a label prediction (otherwise referred to herein as a predicted label) for the unlabeled data sample. Depending on the NN model and the prediction task type, the predicted data generated by a source NN model 112 in respect of an input sample (i.e. an unlabeled data sample of the unlabeled training dataset D̅ can include additional information beyond a label prediction, such as coordinates of a bounding box for an object detected in the input sample (when the input sample is an image) and/or a confidence value.

In some examples, label acquisition module 110 is configured to use the API (and address information if address information is not included in the API) included in the source NN model selection information 102 to access the source NN models 112(1) to 112(N) at one or more of the prediction model markets 120. Accordingly, in some examples the model composition system 100 need not download the source NN models 112(1) to 112(N) and does not require any information about the about the NN model parameters, code or NN model architecture, or the labeled training datasets used to train any of the source NN models 112(1) to 112(N). Thus, the original owners or providers of source NN models 112(1) to 112(N) are not required to provide anything beyond a suitable API, allowing the NN model parameters, code, NN model architecture, and labelled training datasets used to train the source NN models 112(1) to 112(N) to remain confidential. In this regard, the label acquisition module 110 can treat the source NN models 112(1) to 112(N) as black boxes that are each provided with the unlabeled training dataset D̅ to independently generate their respective set of label predictions. The label acquisition module 110 collects the sets of label predictions y̅₁ to y̅_{N} generated by the source NN models 112(1) to 112(N). In addition to protecting the privacy and proprietary structure of the source NN models 112(1) to 112(N), treating the source NN models 112(1) to 112(N) as black boxes also enables the model composition system 100 to be agnostic with regard to characteristics of the source NN models 112(1) to 112(N) such as NN model architecture and hyper-parameters including various optimizers, learning rate schedules, batch sizes, etc.

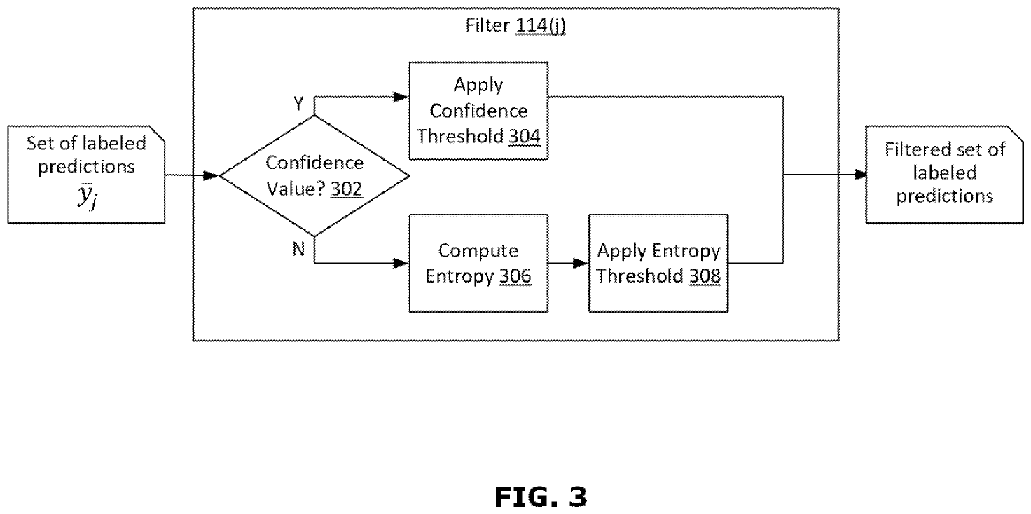

The sets of label predictions y̅₁ to y̅_{N} generated by source NN models 112(1) to 112(N) may not always be sufficiently accurate, with the result that in at least some use cases the sets of label predictions y̅₁ to y̅_{N} can be noisy. In such cases, such noise may have an adverse impact on the training of the target NN model 118. Accordingly, in some examples, filter module 114 is configured to apply respective filtering operations 114(1) to 114(N) to the respective sets of label predictions y̅₁ to y̅_{N} that are generated by the source NN models 112(1) to 112(N). FIG. 3 is a block diagram illustrating operation of a generic filtering operation 114(j) of the filter module 114 in respect of a set of label predictions y̅ⱼ generated by a source model 112 in respect of unlabeled training dataset D̅. In at least some examples, a respective label prediction in the set of label predictions y̅ⱼ received from a source NN model 112 can include a label prediction (i.e. a predicted label) for a respective unlabeled data sample in the unlabeled training dataset D̅, and prediction accuracy data that indicates an accuracy of the label prediction. In example embodiments, filter module 114 is configured to filter out label predictions from the set of label predictions y̅ⱼ to generate a filtered set of labeled predictions. The filter module 114, filters out a given labeled prediction from the set of labeled predictions y̅ⱼ when the prediction accuracy data for the label prediction indicates that the label prediction fails to meet defined prediction confidence criteria.

In some use cases, the prediction accuracy data can be a confidence value that is generated by a source NN model 112 in association with a label prediction for an unlabeled data sample in the unlabeled training dataset D̅. For example, in the case where the prediction task type for the source NN model 112 is object detection, the label prediction that is generated by source model 112 in respect of an input sample (e.g. an image) may include a plurality of detections, each of which corresponds to a detected instance of an object (“detected object instance”). Each detected object instance can have the following associated detected object instance prediction data: (predicted label of the object instance [e.g., “person”]; bounding box definition for the object instance [e.g., ymin=0, xmin=197, ymax=460, xmax=640]; and prediction accuracy data in the form of a confidence value for the predicted label [e.g., 0.95]). In example embodiments, filtering operation 114(j) is configured to determine (decision block 302) if the source model 112 output includes a confidence value for a label prediction, and if so, then apply a predetermined confidence threshold comparison (block 304) to filter out all predictions that have a confidence value that does not exceed the predetermined confidence threshold (for example, 0.4 or higher on a 0-1 value range). Model predictions that achieve the predetermined confidence threshold are kept in the set of label predictions y̅ⱼ, and ones that do not are discarded.

Referring again to decision block 302, in the event that a source NN model 112 output does not include a confidence value for a label prediction, an alternative filter threshold can be applied in some examples, based on a different type of prediction accuracy data. For example, a source model 112 that has a total of C possible output label outcomes may generate an output feature of C logits that respectively correspond to probability values for an object belonging to each of the C candidate prediction labels. A Softmax function can be applied to normalize the logits to between 0 and 1 with a total sum of 1. The logit with the highest value will indicate the predicted label. However, a flat distribution of logit values (e.g., high entropy) can be indicative of a low accuracy. Accordingly, in some examples, the prediction accuracy data that is received from source NN model 112 includes a distribution of logit values for all possible labels for an input sample. An entropy score is computed (block 306) in respect of the C normalized logits, and then compared to a predetermined entropy threshold (block 308) to filter out all label predictions that have an entropy score that exceeds the predetermined entropy threshold. Label predictions that achieve the predetermined entropy threshold are included in the filtered predicted label set y̅ⱼ, and ones that do not are discarded.

In some examples, filtering module 114 may be omitted.

Referring to FIG. 2, the output of filtering module 114 is a composite set of filtered predictions S that includes the N filtered sets of label predictions y̅₁ to y̅_{N}. As noted above, the N filtered sets of labeled predictions y̅₁ to y̅_{N} can be disjointed as the individual label sets y̅₁ to y̅_{N} can be derived from non-identical candidate label sets.

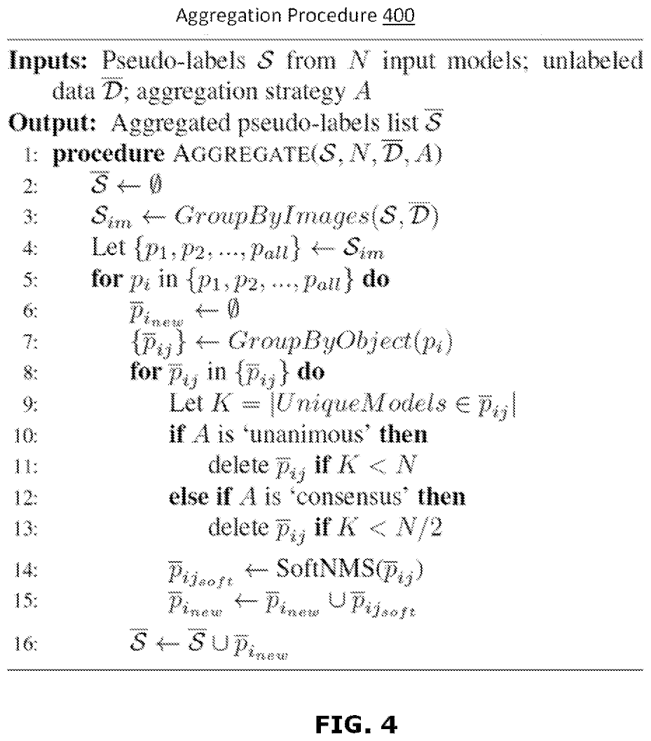

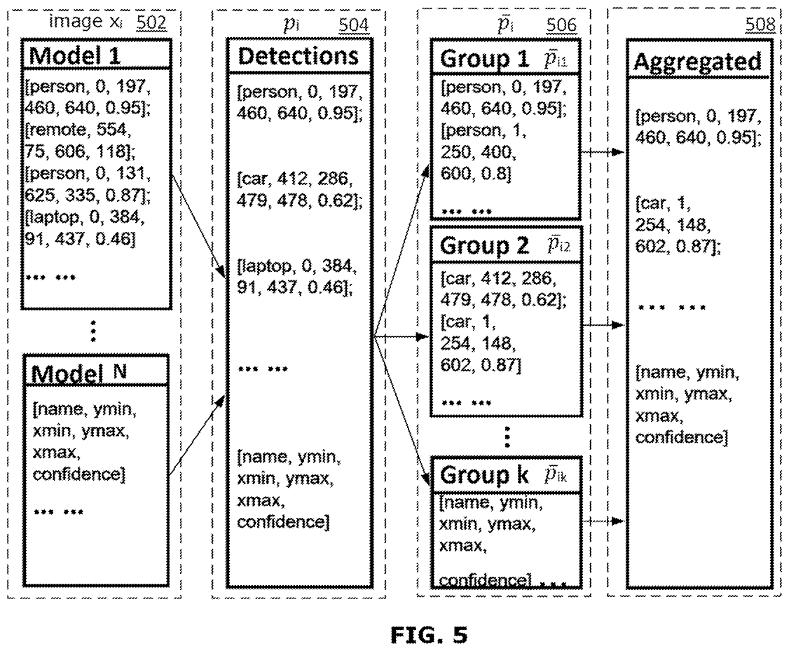

Aggregation module 116 is configured to aggregate, for each input sample, the predictions that correspond to the N filtered predicted label sets y̅₁ to y̅_{N} obtained from source NN models 112(1) to 112(N). FIG. 4 is pseudocode representation of an aggregation procedure 400 performed by the aggregation module 116, according to an example of the present disclosure. FIG. 5 illustrates the aggregation procedure in respect of the filtered label predictions that have been generated in respect of a single unlabeled training data sample xᵢ obtained from the unlabeled training dataset D̅, where the unlabeled data sample xᵢ is an image.

Different aggregation strategies can be applied in different examples to aggregate the filtered predictions S=[y̅₁, . . . , y̅_{N}]. These strategies can include, for example, unanimous aggregation (e.g., all models must agree on same prediction), affirmative aggregation (e.g., union of all predictions), and consensus based aggregation (e.g., simple majority voting or other consensus voting threshold). In the example of FIG. 4, the aggregation strategy, denoted as variable “A”, can be specified by a user, as one of the three possibilities noted above: unanimous aggregation, affirmative aggregation, and consensus based aggregation. In some examples, the aggregation strategy A may be automatically selected based on the prediction task. For example, for a simple type of prediction task, such as image classification, a consensus based majority voting consensus based aggregation strategy may be automatically selected by model composition system 100.

For some prediction task types, such as object detection, aggregation may be more complicated due to the nature of the prediction task type. In this regard, an illustrative example will now be described in the context of aggregation for an object detection, which can also be extended to other similar types of prediction tasks, such as instance segmentation, tracking, etc. With reference to the aggregation procedure 400 of FIG. 4, in the illustrated example the inputs to the aggregation procedure include: (1) the set of filtered predictions S=[y̅₁, . . . , y̅_{N}], where each y̅ⱼ itself is a set of label predictions from a source model 112(h) over all unlabeled training input samples (e.g. images) in the unlabeled training dataset D̅; (2) the unlabeled training dataset D̅; (3) aggregation strategy “A” (e.g., “unanimous”, “consensus”, or “affirmative”).

As indicated at line 3 of aggregation procedure 400, a new set of predictions, Sᵢₘ=[p₁, . . . , pₐₗₗ], is generated, where pᵢ denotes a list of the detected object prediction data for all NN models for one single input data sample xᵢ (e.g., a single image sample) and “all” (e.g., the number of lists p included in Sᵢₘ) is equal to number of all input samples in the unlabeled training dataset D̅. In this regard, block 502 in FIG. 5 illustrates the detected object prediction data included in a single list pᵢ generated for a single image sample xᵢ by the source models 112(1) to 112(N). As can be seen in block 502, in the case of object detection, multiple detected object instances can be provided by each source model 112(1) to 112(N) in respect of a single image sample, with each object detection instance resulting in respective detected object prediction data that includes a label prediction (e.g., object name=“person, “remote”, “person”, “laptop”), a bounding box definition (ymin, xmin, ymax, xmax) and a confidence value (e.g., 0.95). Block 504 illustrates the resulting list pᵢ, which includes the detected object prediction data for all detected object instances for all NN models 112(1) to 112(N) for a single data sample xᵢ. Thus, an aggregated list is generated that includes bounding box predictions and label predictions for each of the objects detected in the input sample by the source NN models.

In the case where the type of prediction task is object detection, multiple label predictions can be generated by each NN model 112(1) to 112(N) in respect of a single input data sample, an additional step of grouping the detected object instances that correspond to the same object can be applied. In this regard, as indicated at block 506 of FIG. 5, the prediction data from each of the NN models 112(1) to 112(N) are grouped based on the predicted labels and bounding box definitions for each of the detected object instances. List p̅ᵢ of block 506 is a version of list pᵢ that has been reorganized into common detected object instance groups, each denoted as Group p̅ᵢₖ, where i={1, . . . ,all} and j={1, . . . ,k}, and k is the number of unique groups. In one example, detected object instances that have (i) overlapping bounding box areas that exceed a predefined overlap threshold and (ii) have the same label prediction, are grouped together as a common detected object instance Group p̅ᵢₖ. By way of example, in “Group 1 p̅ᵢ₁” of block 506 of FIG. 5, the detected object instance [Person,0,197,460,640,0.95] detected by NN model 112(1) is grouped together with the detected object instance [Person, 1,250,400,600,0.8] detected by a another NN model 112(h) based on a determination that the bounding box labelled “person” as detected by NN model 112(0) is overlapped 100% by the bounding box labelled “person” as detected by NN model 112(1), and thus falls within the predefined overlap threshold (e.g., 75%). In some examples, any detected object instance that falls within the defined overlap threshold with respect to any other detected object instance within a group having the same label will be added to that group. Accordingly, in examples where all of models 112(1) to 112(N) include a common label (e.g., “Person”) in their respective candidate label sets, and all models generate labels that meet the criteria of filter module 114, then the number of detected objects instance included in the particular group of detected object instances for that common label should be N. In the example of FIG. 5, there are a total of k groups of detected object instances, with the Group 1 being denoted as p̅ᵢ₁, Group 2 being denoted as p̅ᵢ₂, and Group k being denoted as p̅ᵢₖ. Each group identifies a unique object having the same label predictions and have bounding box predictions that meet a defined overlap criteria

Each of respective group p̅ᵢⱼ, where i={1, . . . ,all) and j={1, . . . ,k), is processed according to the aggregation strategy A to determine if the Group p̅ᵢⱼ should be kept or discarded from the list pᵢ. In aggregation procedure 400 of FIG. 4, the number of detected object instances included in each Group p̅ᵢⱼ is denoted as K (i.e., the number of unique source NN models that have contributed a detected object instance to the Group p̅ᵢⱼ). In the case where a “unanimous” aggregation strategy has been specified, then the Group p̅ᵢⱼ will be discarded if the number K of detected object instances included in the Group p̅ᵢⱼ is less than the number N of source NN models 112(1) to 112(N) (e.g., K<N then delete Group p̅ᵢⱼ; threshold ratio=100%). It will be noted that a “unanimous” aggregation voting strategy will only allow a Group p̅ᵢⱼ to be kept if all source NN models 112(1) to 112(N) have a respective label prediction included in the Group p̅ᵢⱼ. Thus, a “unanimous” aggregation voting strategy may for example be desired when all of the source NN models 112(1) to 112(N) have been trained in respect of the same homogenous set of candidate labels, or alternatively if the desired candidate label set for target model M is the intersection of respective candidate label sets of source NN models 112(1) to 112(N).

In the case where a “consensus” aggregation strategy has been specified, then the Group p̅ᵢⱼ will be discarded if the number K of detected object instances included in the Group p̅ᵢⱼ is less than a defined voting share of the number N of source NN models 112(1) to 112(N) (e.g., if K<N/2 then delete Group p̅_{ij;}; threshold ratio=50%). In various examples, alternative voting thresholds may be specified other than a simple majority (e.g., N/2), such as a super majority (e.g. 2N/3 or 3N/4), or in some examples, a lower than majority threshold (e.g., N/3). A “consensus” voting strategy may for example be desired when source NN models 112(1) to 112(N) have been trained in respect of heterogeneous sets of candidate labels, but a contributions from a minimum percentage of source NN models in respect of a particular label class is desired in order to include such label classes in the target label set for the target NN model M.

In the case where an affirmative aggregation strategy is applied, all of the Groups p̅ᵢ₁ to p̅ᵢₖ are kept. Accordingly, as illustrated in lines 8 to 13 of aggregation procedure 400, a decision is made whether or not to delete each Group p̅ᵢⱼ from the list p̅ᵢ depending on the number of unique NN models with predictions included in the Group p̅ᵢⱼ, denoted by K, using a specified one of three different aggregation strategies: (1) unanimous, in which case Group p̅ᵢⱼ is kept in the list only when all models agree (e.g., K=N); (2) consensus, in which case Group p̅ᵢⱼ is kept when a defined voting threshold is reached (e.g., K≥N/2); and (3) affirmative, in which case a simple stacking strategy is used, and Group p̅ᵢⱼ is kept regardless of K.

After aggregation based filtering of groups occurs, a representative NN model prediction is then selected for each remaining group p̅ᵢⱼ in the list pᵢ. In example embodiments, as illustrated in line 14 of aggregation procedure 400, the representative NN model prediction is selected by performing a soft non-maximum suppression (Soft-NMS) across the predicted labels of the detected object instances included in the Group p̅ᵢⱼ to select a single representative NN model prediction (p̅_{ijsoft}). For example, in the scenario of FIG. 5, for the Group p̅ᵢ₁, the detected object instance [Person,0,197,460,640,0.95] provided by NN model 112(1) is selected to use as the representative NN model prediction p̅_{ijsoft} for the Group pi1.

As indicated at line 15 of aggregation procedure 400, each representative NN model prediction p̅_{ijsoft} is added to a respective group list p̅_{inew} which is a filtered, aggregated list of the predictions for one single data sample xᵢ. Each representative NN model prediction includes a label prediction (e.g., object name=“person, “remote”, “person”, “laptop”), a bounding box definition (ymin, xmin, ymax, xmax), and in some examples a confidence value (e.g., 0.95).

As indicated at line 16, the group lists p̅_{inew} that are computed in respect of all the unlabeled data samples x₁ to xₐₗₗ included in the unlabeled training dataset D̅ are combined to from a filtered, aggregated set of NN model predictions S=[p̅_{1new}, . . . , p̅_{allnew}], where each p̅_{inew} includes a representative label prediction for each unique object instance detected in the unlabeled data sample xᵢ. The model predictions S̅ provide a set of pseudo-labels that can represent an optimal combined performance of all the source NN models 112(1) to 112(N) for the unlabeled training dataset D̅. In this disclosure, a “pseudo-label” can refer to a label that is predicted by a model for an input sample. This can be contrasted to a “ground-truth label”, which can refer to a label for a data sample that has been generated and/or verified by a high confidence entity such as a human. The aggregated set of NN model predictions S̅ and the unlabeled training dataset D̅ are combined by aggregate module 116 to generate pseudo-labeled training dataset D̅={D̅, S̅}.

The above description of aggregation module 116 focused on the example of a prediction type task of object detection where an input sample, which is an image, may include more than one object. It will be appreciated that in the case of a prediction task type where no more than one label prediction is generated by each individual NN model 112(h) for each input sample (i.e. each unlabeled data sample xᵢ in the unlabeled training dataset (e.g., an image classification), grouping by object is not required and an aggregation strategy to select a label prediction for each unlabeled data sample can be performed directly on the contents of list pᵢ, which will include a maximum of N label predictions. For example, in the case of a unanimous aggregation strategy, all of the label predictions for the data sample xᵢ must be the same, and that common label prediction is assigned to the unlabeled data sample xᵢ, otherwise the unlabeled data sample xᵢ will be given a null label prediction. In the case of a consensus aggregation strategy, a voting threshold (e.g., the most commonly occurring label prediction for the unlabeled data sample xi) may be applied to assign a pseudo-label from list pᵢ to the unlabeled data sample xᵢ. In the case of an affirmative aggregation strategy, a combined label prediction comprising all of the label predictions from the list pᵢ may be assigned to the unlabeled data sample xᵢ.

Referring to FIG. 2, in example embodiments the pseudo-labeled training dataset D̅={D̅, S̅}⁻ is provided as an input to training module 118, along with the target NN model M selection information 104. Training module 118 is configured to train target NN model M using the pseudo-labeled training dataset D and semi-supervised learning algorithm to learn values for a set of NN parameters {W,B} of the target NN model M. This results in a trained target NN model M that can be deployed to perform future prediction tasks for new input samples that will map new input samples to one or more of the candidate predictions that are included in the set of model predictions S̅. Target NN model M is an ensemble composition of the source NN models 112(1) to 112(N). In some examples, target NN model M may be uploaded to one or more prediction model markets 120 as a new NN model.

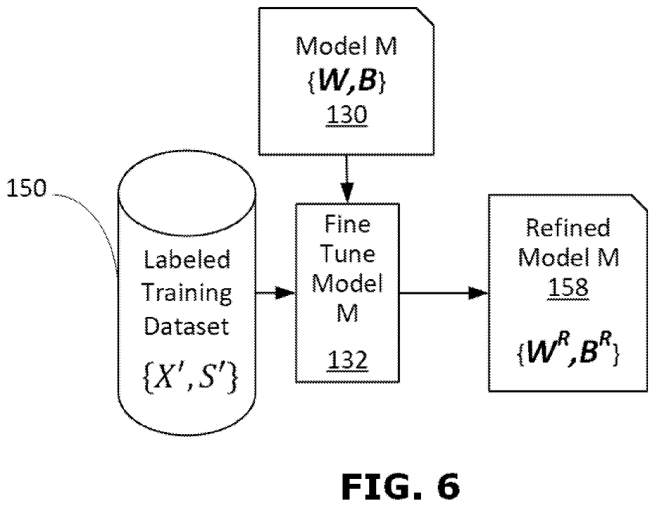

With reference to FIG. 6, in at least some examples, at least some ground-truth labelled training data samples may be available that can be used to further train the trained target NN model M 130. For example, a labelled training dataset 150 comprising labeled data samples where each labeled data sample includes input data and a ground-truth labels associated with the input data. In example embodiments where a ground-truth labelled training dataset 150 is available, the model composition system 100 may also include refinement module 132 for further training a NN model to refine the parameters of the NN model. Refinement module 132 receives the labelled training dataset 150 and the trained target NN model M 130 (including learned NN model parameters {W,B}), and performs further training of the target NN model M using supervised learning and the labelled training dataset 150 to generate a refined target NN model M (including refined learned values for the NN model parameters {W′,B′}).

The target NN model M generated by model composition system 100 is an ensemble composition of the source NN models 112(1) to 112(N). In some examples, target NN model M may be downloaded by the user device 122. In some examples, target NN model M may be uploaded to one or more prediction model markets 120 as a new NN model.

As noted above, in the context of object-detection, examples of source NN models could have, among others, “EfficientDET-D0” “EfficientDET-D1”; “EfficientDET-D0”, and/or “RetinaNet-ResNet50” model architectures and the source NN models are trained using one or more of, or selected subsets of, the Pascal-VOC, COCO, and/or Open-Images-V5 labelled training datasets. In the context of image classification, examples of source NN models could include, among others, “ResNet-18”, “ResNet-152” and DenseNet-121″, NN model architectures and the source NN models are trained using one or more of, or selected subsets of, the Caltech-256 and/or Open-Images-V5 labelled training datasets. Experiments performed using combinations of the above architectures and training datasets and evaluated using mean Average Precision, mAP@IoU=0.50:0.95 as a performance metric indicated that the resulting composite target NN model could be trained using an unlabeled training dataset to achieve satisfactory performance when compared to fully supervised training of the same NN model.

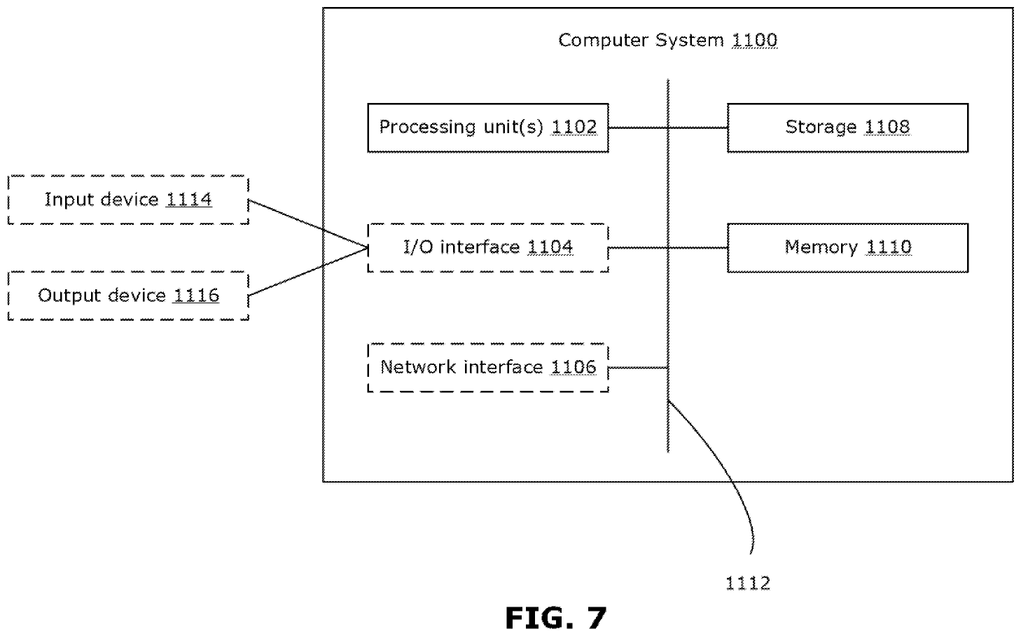

FIG. 7 is a block diagram of an example simplified computer system 1100, which may be part of a system or device that implements one or more of the modules, training module and/or more of the other functions, modules, modes, systems and/or devices described above, including the model composition system 100. Other computer systems suitable for implementing embodiments described in the present disclosure may be used, which may include components different from those discussed below. Although FIG. 7 shows a single instance of each component, there may be multiple instances of each component in the computer system 1100.

The computer system 1100 may include one or more processing units 1102, such as a processor, a microprocessor, an application-specific integrated circuit (ASIC), a field-programmable gate array (FPGA), or combinations thereof. The one or more processing units 1102 may also include other processing units (e.g. a Neural Processing Unit (NPU), a tensor processing unit (TPU), and/or a graphics processing unit (GPU)).

Optional elements in FIG. 7 are shown in dashed lines. The computer system 1100 may also include one or more optional input/output (I/O) interfaces 1104, which may enable interfacing with one or more optional input devices 1114 and/or optional output devices 1116. In the example shown, the input device(s) 1114 (e.g., a keyboard, a mouse, a microphone, a touchscreen, and/or a keypad) and output device(s) 1116 (e.g., a display, a speaker and/or a printer) are shown as optional and external to the computer system 1100. In other examples, one or more of the input device(s) 1114 and/or the output device(s) 1116 may be included as a component of the computer system 1100. In other examples, there may not be any input device(s) 1114 and output device(s) 1116, in which case the I/O interface(s) 1104 may not be needed.

The computer system 1100 may include one or more optional network interfaces 1106 for wired (e.g. Ethernet cable) or wireless communication (e.g. one or more antennas) with a network (e.g., an intranet, the Internet, a P2P network, a WAN and/or a LAN).

The computer system 1100 may also include one or more storage units 1108, which may include a mass storage unit such as a solid-state drive, a hard disk drive, a magnetic disk drive and/or an optical disk drive. The computer system 1100 may include one or more memories 1110, which may include both volatile and non-transitory memories (e.g., a flash memory, a random access memory (RAM), and/or a read-only memory (ROM)). The non-transitory memory (ies) 1110 may store instructions for execution by the processing unit(s) 1102 to implement the modules and NN models of the model composition system 100 disclosed herein. The memory (ies) 110 may include other software instructions, such as implementing an operating system and other applications/functions.

Examples of non-transitory computer-readable media include a RAM, a ROM, an erasable programmable ROM (EPROM), an electrically erasable programmable ROM (EEPROM), a flash memory, a CD-ROM, or other portable memory storage.

There may be a bus 1112 providing communication among components of the computer system 1100, including the processing unit(s) 1102, optional I/O interface(s) 1104, optional network interface(s) 1106, storage unit(s) 1108 and/or memory (ies) 1110. The bus 1112 may be any suitable bus architecture, including, for example, a memory bus, a peripheral bus or a video bus.

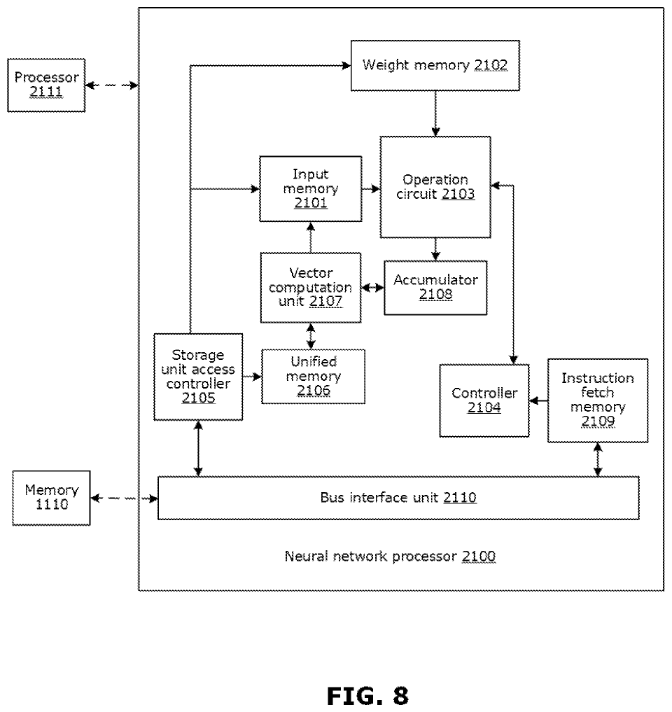

FIG. 8 is a block diagram illustrating an example hardware structure of an example NN processor 2100 of the processing unit 102 to implement a NN model (such as target NN model M or source N models 112) according to some example embodiments of the present disclosure. The NN processor 2100 may be provided on an integrated circuit (also referred to as a computer chip). All the algorithms of the layers of an NN may be implemented in the NN processor 2100.

The processing units(s) 1102 (FIG. 7) may include a further processor 2111 in combination with NN processor 2100. The NN processor 2100 may be any processor that is applicable to NN computations, for example, a Neural Processing Unit (NPU), a tensor processing unit (TPU), a graphics processing unit (GPU), or the like. The NPU is used as an example. The NPU may be mounted, as a coprocessor, to the processor 2111, and the processor 2111 allocates a task to the NPU. A core part of the NPU is an operation circuit 2103. A controller 2104 controls the operation circuit 2103 to extract matrix data from memories (2101 and 2102) and perform multiplication and addition operations.

In some implementations, the operation circuit 2103 internally includes a plurality of processing units (Process Engine, PE). In some implementations, the operation circuit 2103 is a bi-dimensional systolic array. Besides, the operation circuit 2103 may be a uni-dimensional systolic array or another electronic circuit that can implement a mathematical operation such as multiplication and addition. In some implementations, the operation circuit 2103 is a general matrix processor.

For example, it is assumed that there are an input matrix A, a weight matrix B, and an output matrix C. The operation circuit 2103 obtains, from a weight memory 2102, weight data of the matrix B and caches the data in each PE in the operation circuit 2103. The operation circuit 2103 obtains input data of the matrix A from an input memory 2101 and performs a matrix operation based on the input data of the matrix A and the weight data of the matrix B. An obtained partial or final matrix result is stored in an accumulator (accumulator) 2108.

A unified memory 2106 is configured to store input data and output data. Weight data is directly moved to the weight memory 2102 by using a storage unit access controller 2105 (Direct Memory Access Controller, DMAC). The input data is also moved to the unified memory 2106 by using the DMAC.

A bus interface unit (BIU, Bus Interface Unit) 2110 is used for interaction between the DMAC and an instruction fetch memory 2109 (Instruction Fetch Buffer). The bus interface unit 2110 is further configured to enable the instruction fetch memory 2109 to obtain an instruction from the memory 1110, and is further configured to enable the storage unit access controller 2105 to obtain, from the memory 1110, source data of the input matrix A or the weight matrix B.

The DMAC is mainly configured to move input data from memory 1110 Double Data Rate (DDR) to the unified memory 2106, or move the weight data to the weight memory 2102, or move the input data to the input memory 2101.

A vector computation unit 2107 includes a plurality of operation processing units. If needed, the vector computation unit 2107 performs further processing, for example, vector multiplication, vector addition, an exponent operation, a logarithm operation, or magnitude comparison, on an output from the operation circuit 2103. The vector computation unit 2107 is mainly used for computation at a neuron or a layer (described below) of a neural network.

In some implementations, the vector computation unit 2107 stores a processed vector to the unified memory 2106. The instruction fetch memory 2109 (Instruction Fetch Buffer) connected to the controller 2104 is configured to store an instruction used by the controller 2104.

The unified memory 2106, the input memory 2101, the weight memory 2102, and the instruction fetch memory 2109 are all on-chip memories. The memory 1110 is independent of the hardware architecture of the NPU 2100.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium and includes several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations but are not intended to limit the scope of protection. Any variation or replacement readily figured out by a person skilled in the art within the technical scope shall fall within the scope of protection. Therefore, the scope of protection shall be subject to the protection scope of the claims.

1. A method for generating a composite neural network (NN) model that is based on a group of source NN models, comprising:
providing an unlabeled training dataset including a plurality of input samples to each of the source NN models;
receiving, from each of the source NN models, a respective set of label predictions generated from the input samples of the unlabeled training dataset;
selecting, from among the received sets of label predictions, representative label predictions to use as pseudo-labels for the input samples; and
performing supervised training of a target NN model using the pseudo-labels and the input samples to generate the composite NN model.

2. The method of claim 1 wherein the source NN models are each configured to generate a respective set of label predictions by mapping input samples to one label prediction included in a respective set of candidate labels, wherein at least some of the source NN models have different respective sets of candidate labels.

3. The method of claim 1 wherein the received sets of label predictions include prediction accuracy data that indicates a prediction accuracy, and selecting representative label predictions to use as pseudo-labels for the input samples comprises filtering label predictions based on the prediction accuracy data.

4. The method of claim 3 wherein the prediction accuracy data comprises label prediction confidence values for at least some of the label predictions, and filtering label predictions based on the prediction accuracy data comprises removing label predictions from the received sets of label predictions that do not meet a threshold label prediction confidence value.

5. The method of claim 3 wherein the prediction accuracy data comprises probabilities for all possible label predictions for at least some of the label predictions, and filtering label predictions based on the prediction accuracy data comprises:
calculating an entropy score for each of the at least some label predictions based a distribution of the probabilities for all possible label predictions for the label prediction; and
removing label predictions from the received sets of label predictions that do not meet a threshold entropy score.

6. The method of claim 1 wherein selecting representative label predictions to use as pseudo-labels for the input samples comprises:
aggregating, for each input sample, a list of label predictions that the source NN models have predicted for the input sample, and selecting the representative label prediction for the input sample from the list of label predictions for the input sample.

7. The method of claim 6 wherein the source NN models are each configured to perform image classification and output a highest probability label prediction for each input sample, wherein selecting the representative label prediction for the input sample from the list of label predictions for the input sample is based on selecting the label prediction having a highest associated probability.

8. The method of claim 1 wherein the source NN models are each configured to perform an object detection task prediction wherein objects are detected in each input sample and associated with a respective bounding box prediction and object label prediction, wherein selecting representative label predictions to use as pseudo-labels for the input samples comprises:
for each input sample:
aggregating a list of bounding box predictions and label predictions for each of the objects detected in the input sample by the source NN models;
identifying each unique object having bounding box predictions and label predictions included in the list by identifying objects that have the same label predictions and have bounding box predictions that meet a defined overlap criteria;
selecting an object label for each of the identified unique objects from the label predictions provided by the source NN models in respect of the unique objects; and
using the selected object labels as the representative label predictions for the input sample.

9. The method of claim 8 further comprising filtering the identified unique objects prior to selecting the object labels, comprising removing from the identified unique objects any objects that have not been provided the same label prediction by a threshold ratio of the source NN models.

10. The method of claim 9 comprising receiving an input from a user interface indicating the threshold ratio.

11. The method of claim 1 comprising:
receiving, through a user interface, selection information indicating the source NN models to include in the group of source NN models, wherein the source NN models are all configured to perform a same type of prediction task that is intended for the target NN model, but at least one of the source NN models has a different NN model architecture than one or more of the other source NN models.

12. The method of claim 11 wherein providing the dataset to each of the source NN models comprises submitting the dataset through a cloud network to the source NN models.

13. The method of claim 11 comprising receiving, through the user interface, target model selection information indicating the intended type of prediction task for the target NN model and a model architecture for the target NN model.

14. A computer system comprising one or more processing units and one or more non-transient memories storing computer implementable instructions for execution by the one or more processing devices, wherein execution of the computer implementable instructions configures the computer system to generate a composite neural network (NN) model that is based on a group of source NN models, by performing a method comprising:
providing a dataset including a plurality of input samples to each of the source NN models;
receiving, from each of the source NN models, a respective set of label predictions for the input samples of the dataset;
selecting, from among the received sets of label predictions, representative label predictions to use as pseudo-labels for the input samples; and
performing supervised training of a target NN model using the pseudo-labels and the input samples to generate the composite NN model.

15. The system of claim 14 wherein the source NN models are each configured to generate a respective set of label predictions by mapping input samples to one label prediction included in a respective set of candidate labels, wherein at least some of the source NN models have different respective sets of candidate labels.

16. The system of claim 14 wherein the source NN models are each configured to perform image classification and output a highest probability label prediction for each input sample, and selecting representative label predictions to use as pseudo-labels for the input samples comprises:
for each input sample aggregating a list of label predictions that the source NN models have predicted for the input sample, and the label prediction having a highest associated probability within the list of label predictions as the representative label prediction for the input sample.

17. The system of claim 14, wherein the method further comprises:
receiving, through a user interface, selection information indicating the source NN models to include in the group of source NN models, wherein the source NN models are all configured to perform a same type of prediction task that is intended for the target NN model, but at least one of the source NN models has a different NN model architecture than one or more of the other source NN models.

18. The system of claim 17 wherein providing the dataset to each of the source NN models comprises submitting the dataset through a cloud network to the source NN models.

19. The system of claim 17, wherein the method further comprises receiving, through the user interface, target model selection information indicating the intended type of prediction task for the target NN model and a model architecture for the target NN model.

20. A non-transient computer readable medium storing computer implementable instructions that configures a computer system to perform a method comprising:
providing an unlabeled training dataset including a plurality of input samples to each of the source NN models;
receiving, from each of the source NN models, a respective set of label predictions generated from the input samples of the unlabeled training dataset;
selecting, from among the received sets of label predictions, representative label predictions to use as pseudo-labels for the input samples; and
performing supervised training of a target NN model using the pseudo-labels and the input samples to generate the composite NN model.
